(19) United States
(12) Patent Application Publication
(10) Pub. No.: US 2026/0024362 A1
(43) Pub. Date: Jan. 22, 2026

(54) SEMANTIC SEGMENTATION FOR FIRE DETECTION

(71) Applicant: Kidde Technologies Inc., Wilson, NC (US)

(72) Inventor: Zachary Bloom, Raleigh, NC (US)

(21) Appl. No.: 18/778,131

(22) Filed: Jul. 19, 2024

(51) Int. Cl. G06V 20/70; G06V 10/26; G06V 10/40; G06V 10/774; G06V 10/82; G06V 20/52

(52) U.S. Cl. CPC G06V 20/70; G06V 10/26; G06V 10/40; G06V 10/774; G06V 10/82; G06V 20/52

(57) ABSTRACT

An improved fire detection system integrates semantic segmentation into a deep learning model to detect and verify fires. The fire detection system includes a fire detection module, a sensor signal, a fire sensor, a fire zone image, a confirmation module, and a control unit.

### BACKGROUND

The present disclosure relates generally to a fire detection system, and more particularly, to a fire detection system that uses a confirmation module to confirm signals from a fire sensor.

The aviation fire alarm and detection industry has a growing interest in reducing the number of false alarms generated by fire detection systems. False alarms by fire detection systems, such as fire detectors or smoke detectors, can be particularly frustrating for the pilot and crew members who rely on these devices for their safety and passengers in the sky. There is a need for an improved fire detection system that reduces the number of false alarms created.

### SUMMARY

One aspect of this disclosure is directed to a fire detection system that includes a trained deep learning model and a fire detection module. The trained deep learning model receives an image, detects a fire in the image, and outputs a fire status report. During training of the deep learning model, semantic segmentation, multiple images, and multiple masks are used to create the trained deep learning model. Each mask in the set of masks used during training of the deep learning includes at least one label, and each label categorizes a portion of the mask. A portion of a mask is either a subsection of the mask or is the entire mask. The fire status report indicates whether fire is present in an image. The fire detection module receives an initial input, an image, and a fire status report, and outputs the fire status report to a control unit. The fire detection module uses the initial input as an indication to check for a fire. The fire detection module captures an image using the fire detection system or receives the image from an external source. The fire detection module sends the image to the trained deep learning model and receives the fire status report from the trained deep learning model.

Another aspect of this disclosure is directed to a method of operating a fire detection system that includes receiving an initial input to a fire detection module, capturing an image internally or importing the image from an external source, sending the image to a trained deep learning model from, the fire detection module, receiving the image to the trained deep learning model, analyzing the image using the trained deep learning model, generating a fire status report using the trained deep learning model, sending the fire status report from the trained deep learning model to the fire detection module, and sending the fire status report from the fire detection module to a control unit.

### BRIEF DESCRIPTION OF THE DRAWINGS

FIG. 1 is a block diagram of a fire detection system.

FIG. 2 is a flow chart showing the operation of the fire detection system of FIG. 1.

FIG. 3A is a diagram illustrating the digital logic when a fire sensor detects a signal and a fire status report is not generated.

FIG. 3B is a diagram illustrating the digital logic when a fire sensor detects a signal and a fire status report is generated.

FIG. 3C is a diagram illustrating the digital logic when a fire sensor does not detect a signal and a fire status report is generated.

FIG. 4A is a diagram illustrating the digital logic when a fire sensor does not detect a signal, a fire status report is generated, and a smoke detector detects a signal.

FIG. 4B is a diagram illustrating the digital logic when a fire sensor does not detect a signal, a fire status report is not generated, and a smoke detector detects a signal.

FIG. 5 is a diagram contrasting an optimal state estimate from a predicted state estimate and a measurement.

FIG. 6 is a diagram contrasting multiple optimal state estimates from multiple predicted state estimates and multiple measurements.

FIG. 7 is a block diagram of a method for training a confirmation module of the fire detection system of FIG. 1.

FIG. 8 is a more detailed block diagram of the setup phase of FIG. 7.

FIG. 9 is a more detailed block diagram of the training, testing, and post-testing phases of FIG. 7.

FIG. 10A is an example of a fire image obtained by the fire detection module of the fire detection system of FIG. 1.

FIG. 10B shows the fire image of FIG. 10A with classes outlined.

### DETAILED DESCRIPTION

The present disclosure is directed to a method and apparatus for operating a fire detection system that uses deep learning to perform semantic segmentation tasks to increase the effectiveness of fire detection and verification. The disclosed method and apparatus can be used to supplement an existing fire detection system including a fire detector and/or a smoke detector.

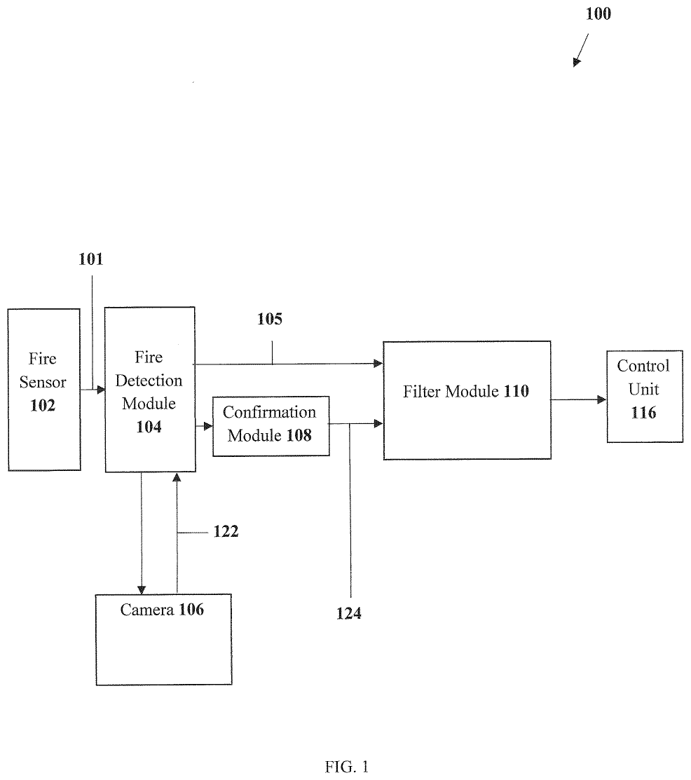

### Simplified Block Diagram of Fire Detection System 100 (FIG. 1)

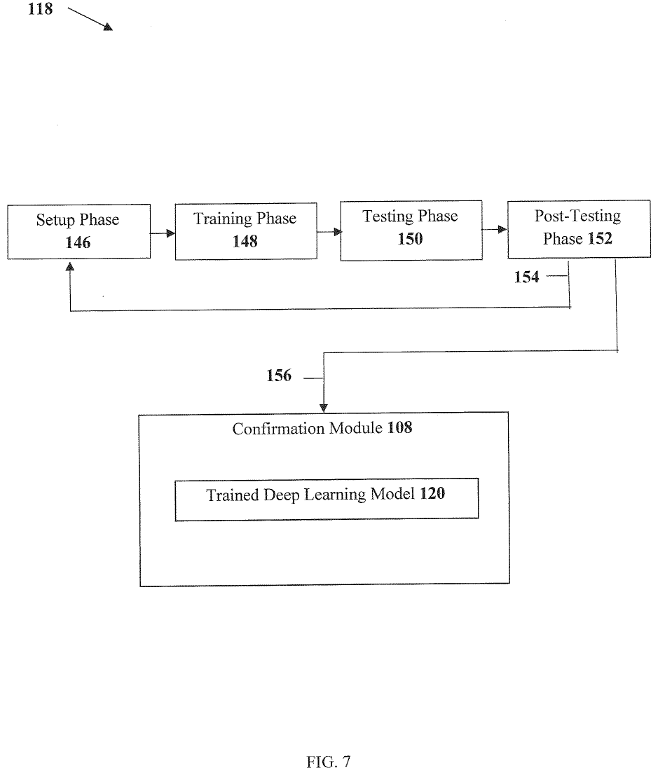

FIG. 1 is a block diagram of fire detection system 100. Fire detection system 100 can, for example, include fire sensor 102, sensor signal 101, fire detection module 104, detector signal 105, camera 106, fire image 122, confirmation module 108, fire status report 124, filter module 110, and control unit 116. FIG. 1 provides a high-level block diagram of how the major pieces within fire detection system 100 interact with each other. Fire detection system 100 uses deep learning (DL) training module 118 (shown in FIG. 7) to create trained DL model 120. Once trained DL model 120 has been created, fire detection system 100 is able to detect and verify fires.

Fire detection system 100 begins operation when fire detection module 104 receives sensor signal 101 from fire sensor 102. Once sensor signal 101 is received, fire detection module 104 receives an image from camera 106 and sends the image to confirmation module 108. Confirmation module 108 receives the image, analyzes the image for fire using trained DL model 120, generates a fire status report (which says if fire is found in the image), and sends the fire status report to filter module 110. Filter module 110 inputs the fire status report and detector signal 105 into filter module 110, which includes digital logic. The digital logic in filter module 110 uses the fire status report and detector signal 105 to generate an output signal indicating whether fire is present or not. Then, filter module 110 sends the output signal to control unit 116. Fire detection system 100 uses semantic segmentation to improve fire detection and verification.

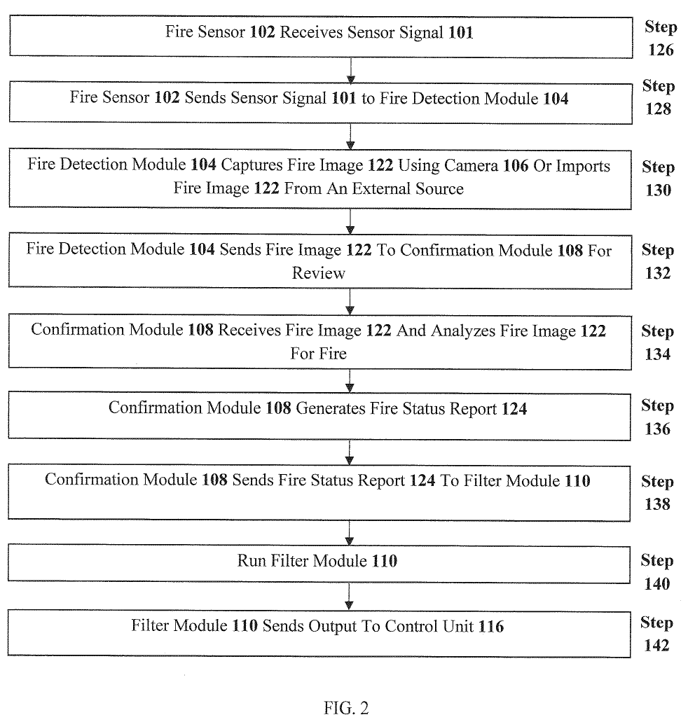

### Simplified Block Diagram Showing the Operation of the Fire Detection System of FIG. 1. (FIG. 2)

FIG. 2 is a flow chart showing the operation of the fire detection system of FIG. 1. Fire detection system 100 can include all of the parts described in FIG. 1 and can further include, for example, fire image 122, and fire status report 124. FIG. 2 shows method steps for fire detection system 100 which can include, for example, steps 126, 128, 130, 132, 134, 136, 138, 140, and 142. FIGS. 1 and 2 will be discussed together. Fire detection system 100 is hereby described after initial training has been completed and trained DL model 120 has been created and stored in the memory of fire detection system 100. Fire detection system 100 commences operation when it receives sensor signal 101 from fire sensor 102 (Step 126).

### Sensor Signal

Sensor signal 101 can be any input that alerts fire sensor 102 that there is a potential fire in a fire zone (Step 126). Examples of sensor signal 101 include an electrical signal, smoke, heat, flames, etc. Fire sensor 102 can be any kind of sensor including, any kind of smoke detector, an optical smoke detector, a photoelectric smoke detector, an ionization smoke detector, a multi-sensor detector, any kind of heat detector, a thermal heat detector, a thermovelocimetric heat detector, any kind of flame detector, an ultraviolet detector, an infrared detector, a multi-spectrum detector, optical flame detector, a visual flame imaging detector, a gas detector, an electric detector, photodiodes, thermopiles, etc. In one example, fire detection system 100 can be connected to any number of fire sensors 102. Fire sensors 102 can be multiple different types of fire sensors 102 (example: fire detection system 100 could be connected to a smoke detector, a heat detector, and a flame detector). A fire zone is an area in which a potential fire may be present.

Fire sensor 102 sends fire sensor signal 101 to fire detection module 104 (Step 128). The purpose of fire sensor 102 is to alert fire detection system 100 that a fire has potentially been detected. In one example, fire sensor 102 alerts fire detection system 100 when a fire may be about to begin before the fire actually starts. The fire sensor signal 101 could indicate the presence or absence of smoke, heat, flame, etc. or could additionally provide information about the intensity of smoke, heat, flame, etc.

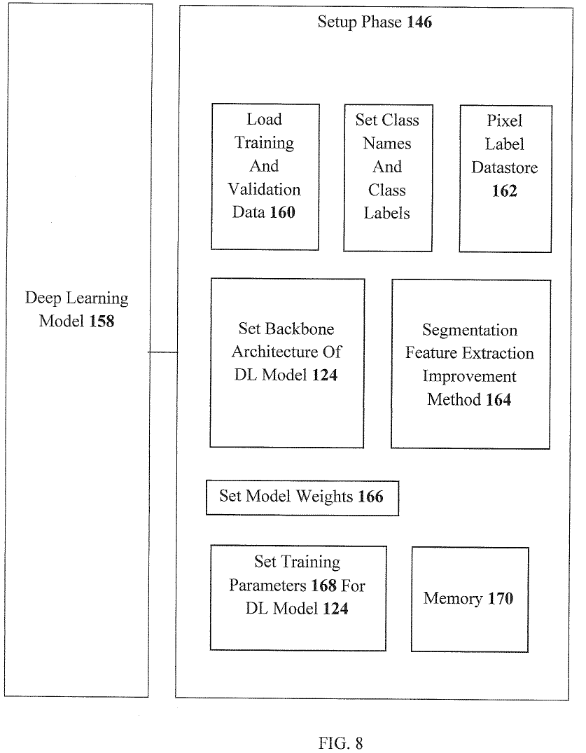

Fire detection module 104 receives fire sensor signal 101 from fire sensor 102 (Step 128). Fire detection module 104 can execute software, applications, and/or programs stored on memory 170 (see FIG. 8) or any other memory associated with fire detection system 100. Fire detection module 104, camera 106, confirmation module 108, filter module 110, control unit 116, and DL training module 118, can include a processor. Examples of processors can include one or more of a processor, a microprocessor, a controller, graphics processor units (GPU), central processor units (CPU), a digital signal processor (DSP), an application specific integrated circuit (ASIC), a field-programmable gate array (FPGA), system-on-a-chip (SoC), or other equivalent discrete or integrated logic circuitry. In some examples, memory 170 or any other memory associated with fire detection system 100 is used to store program instructions for execution by the processor. Each module in fire detection system 100 can include one or more processors suitable for implementing the tasks assigned to fire detection system 100. For example, each module in fire detection system 100 can include one or more central processing units (CPU), graphics processing units (GPU), etc.

When fire detection module 104 receives fire sensor signal 101 it performs two actions simultaneously. Fire detection module 104 sends detector signal 105 to filter module 110 indicating that fire sensor 102 detected a fire. Fire detection module 104 also begins the process of verifying if there is a fire by capturing an image of the fire (step 130). In one example, these two actions can be performed by fire detection module 104 in any order (in parallel or in series). In one example, detector signal 105 can be the same as fire sensor signal 101. If fire detection module 104 has the logic capabilities, it can be configured to compare the confirmation module 108 with the fire sensor 102.

### Fire Image

Fire detection module 104 receives fire sensor signal 101. Then fire detection module 104 obtains fire image 122 or video of the fire (step 130).

Fire image 122 is a digital image of the potential fire in a fire zone. Fire image 122 can be in any image format including png, tiff, eps, pdf, webp, jpeg, etc. PNG and Tiff can be a desired format for semantic segmentation tasks described below due to their lossless compression and support for transparency. A video of the fire in a fire zone can also be sent to fire detection module 104. The video can be spliced into individual images (screenshots or snapshots of still frames in the video), and then the individual images can be used as fire image(s) 122 by fire detection module 104.

Fire detection module 104 can obtain fire image 122 in various ways. Fire detection module 104 can receive fire image 122 from outside fire detection system 100 without fire detection system 100 requesting fire image 122. Or receiving sensor signal 101 can trigger fire detection module 104 to either cause fire image 122 to be captured or import fire image 122 from an external camera outside of fire detection system 100 (such as an external camera to which fire detection module 104 is wirelessly connected). An example of a source outside of fire detection system 100 that can be used to obtain fire image 122 is an electronic device or camera that can electrically communicate with fire detection system 100.

### Camera

Camera 106 can be any camera or instrument that is capable of capturing images in any appropriate portion of the electromagnetic spectrum. Examples of camera 106 include ultraviolet cameras, visible light cameras, infrared cameras, an internal camera, and an external camera. In one example, after receipt of sensor signal 101 fire detection module 104 causes camera 106 to capture an image of the fire.

Camera 106 can be a camera that is mounted on and electrically connected to fire detection system 100 in any manner known within the art, including directly or indirectly connected to the fire detection module 104. In this example, fire detection module 104 can cause fire image 122 to be captured using camera 106 without needing to communicate with the rest of fire detection system 100. In another example, camera 106 can be directly or indirectly accessed from an external source. An example of camera 106 being directly accessed from external source is when camera 106 is not directly internally connected to fire detection system 100, but camera 106 is externally electrically connected to fire detection system 100 or in electronic communication with fire detection system 100 (including communication using Bluetooth or some other frequency). So, in this example, fire detection module 104 can electrically communicate with camera 106 located on an external source and cause fire image 122 to be captured.

In another example, camera 106 can be indirectly accessed from an external source, such as communicating with an airplane control system, building security, etc. In this example, fire detection module 104 sends a prompt to an external source (such as an airplane control system, building security, etc.) for fire image 122. The external source sends fire image 122 to fire detection module 104. Fire detection module 104 then receives (through any electronic communication technique such as importing) fire image 122.

In another example, fire detection module 104 can turn camera 106 on or off. Fire detection module 104 can turn camera 106 on when fire detection module 104 receives sensor signal 101. Fire detection module 104 can turn camera 106 off when fire detection module 104 receives fire image 122 or fire detection module 104 can turn camera 106 off after a set duration of time determined by the programming of fire detection module 104.

### Confirmation Module

Once fire detection module 104 has fire image 122, fire detection module 104 sends fire image 122 to confirmation module 108 (step 132). Once confirmation module 108 receives fire image 122 from fire detection module 104, confirmation module 108 begins fire detection and verification. Confirmation module 108 includes trained DL model 120. As discussed in more detail below, trained DL model 120 is created by DL training module 118.

Confirmation module 108 uses trained DL model 120 created through a previous deep learning training to identify any fire present in fire image 122 (step 134). Confirmation module 108 can analyze fire image 122 in the same way that test images 180 were evaluated during deep learning training as discussed below. Confirmation module 108 can analyze each pixel in fire image 122 for attributes. These attributes (e.g., “classes”) can be fire attributes, smoke attributes, or any other attribute that trained DL model 120 has been trained to identify. Confirmation module 108 can extract attribute data from each pixel in fire image 122. Confirmation module 108 can create a segmentation map using the extracted attribute data from each pixel in fire image 122 and use the segmentation map to determine the presence of fire and/or smoke in fire image 122 based on the analysis of the attribute data of each pixel in fire image 122. In one example, visual representations of the prediction output(s) of confirmation module 108 can be created in certain scenarios and sent to filter module 110 or control unit 116.

Once the analysis of fire image 122 is completed, confirmation module 108 generates fire status report 124 (step 136).

### Fire Status Report

Fire status report 124 provides a determination (that is created by confirmation module 108) of whether a fire is present in fire image 122. In one example, fire status report 124 can be a status: Yes (there is fire present in fire image 122) or No (there is not fire present in fire image 122). Fire status report 124 can be digitalized so that control unit 116 can interpret the results.

In another example, fire status report 124 can include fire image 122, all attribute data extracted from analyzing each pixel in fire image 122, information about camera 106 that captured fire image 122 (e.g., the location of the camera, the time the fire image was captured, etc.), the presence of fire in fire image 122, and more specific information about the fire's location in fire image 122. Once fire status report 124 has been generated by confirmation module 108, confirmation module 108 sends fire status report 124 to filter module 110 (step 138) to be compared with detector signal 105.

In another example, confirmation module 108 can receive multiple fire images 122 from fire detection module 104 and can generate multiple fire status reports 124. One fire status report can be generated for each fire image 122. An overall fire status report or consensus can also be determined from the results of each fire image 122.

In one example, fire status report 124 can identify the location of the fire and/or smoke and calculate the percentage of the fire or smoke present in fire image 122. Knowing the percentage of the fire or smoke present in fire image 122 can help the flight crew or control unit 116 discharge the appropriate amount of fire suppression substance from the fire extinguishers onboard the aircraft and/or other vehicles that are connected to fire detection system 100.

### Filter Module

Filter module 110 is designed to receive detector signal 105 from fire detection module 104 and fire status report 124 from confirmation module 108. Once both of these inputs to filter module 110 are received, filter module 110 makes a further determination of whether a fire is present in a fire zone. Filter module 110 can face three scenarios when it processes detector signal 105 from fire detection module 104 and/or fire status report 124 from confirmation module 108.

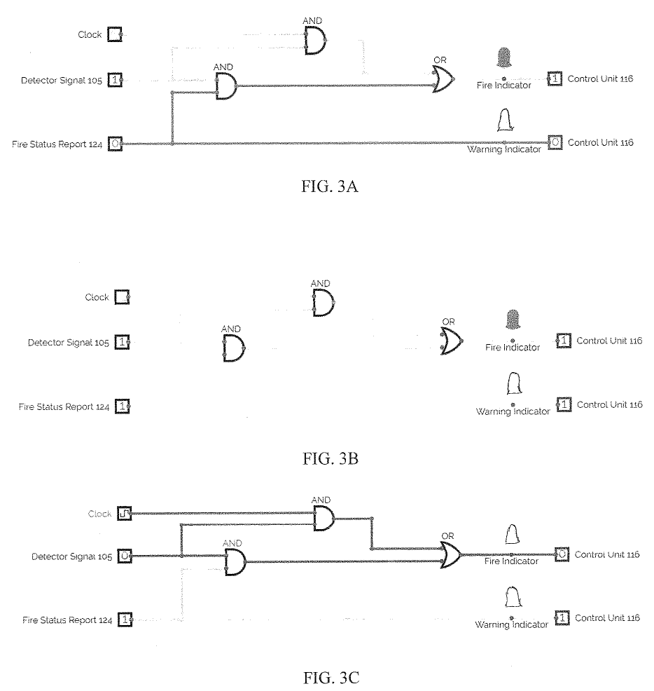

Scenario 1 (see FIG. 3A): Fire detection module 104 (through detector signal 105) indicates the presence of a fire in a fire zone and there is no fire present from fire status report 124 from confirmation module 108. If the detector signal 105 exists in a fire state for a long enough duration, then the filter module 110 can override fire status report 124 and declare a fire is present in the fire zone. Scenario 2 (see FIG. 3B): both fire status report 124 and detector signal 105 indicate a fire in a fire zone. Scenario 3 (see FIG. 3C): filter module receives no detector signal 105, but fire status report 124 indicates that there is a fire in a fire zone.

In scenario 1, filter module 110 receives detector signal 105 from fire detection module 104. If detector signal 105 is sustained for the predetermined amount of time, then a fire signal will be sent to control unit 116 to confirm a fire was detected. This will happen regardless of whether fire status report 124 detects a fire. If detector signal 105 terminates before the predetermined time and confirmation module 108 does not output a fire status report, then filter module 110 will not output a signal to control unit 116 indicating the detection of a fire.

In scenario 2, both detector signal 105 and fire status report 124 detect a fire and therefore control unit 116 is notified of a fire. In scenario 3, the detector signal 105 either does not detect a fire or does not maintain the detection for the predetermined amount of time. However, fire status report 124 still indicates the presence of a fire and therefore a warning signal is sent to control unit 116. This warning signal allows the pilot and flight crew to either investigate the situation or monitor the condition to ensure it does not get any worse. In one example, the pilot or crew member can take control over camera 106 to visually inspect the fire zone in the event a fire is detected by the fire status report 124 but not the detector signal 105. In this example the pilot or crew member can manually send a signal to control unit 116 to discharge fire extinguishers if a fire is observed. In all the scenarios, the filter module 110 waits for a signal from either fire detection module 104 (the signal is detector signal 105) or fire status report 124 to use digital logic to direct the signal to the appropriate response.

### Filter Module Logic

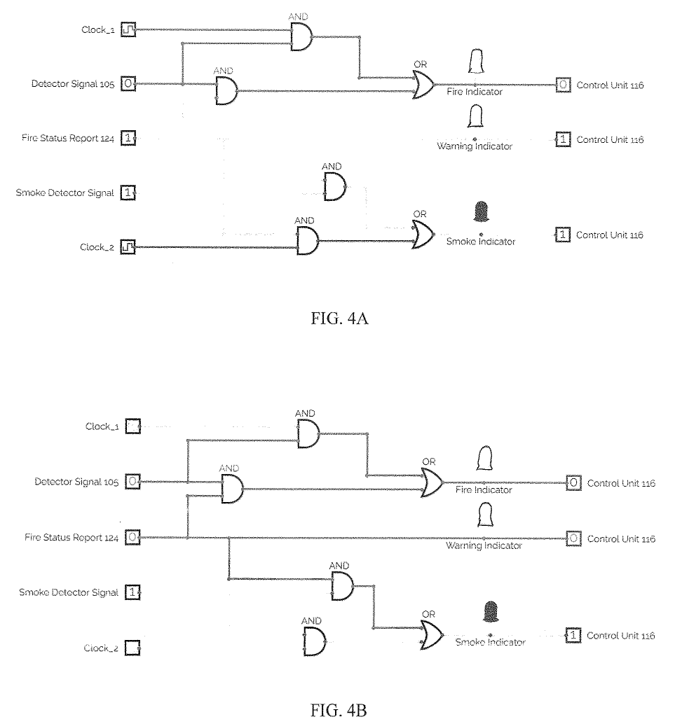

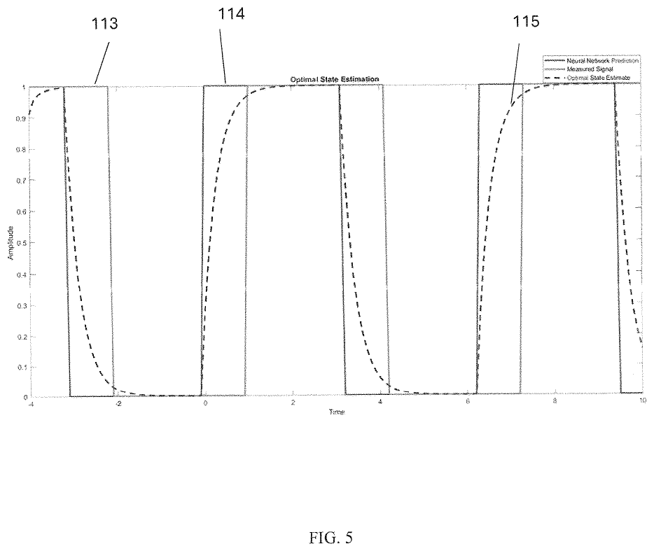

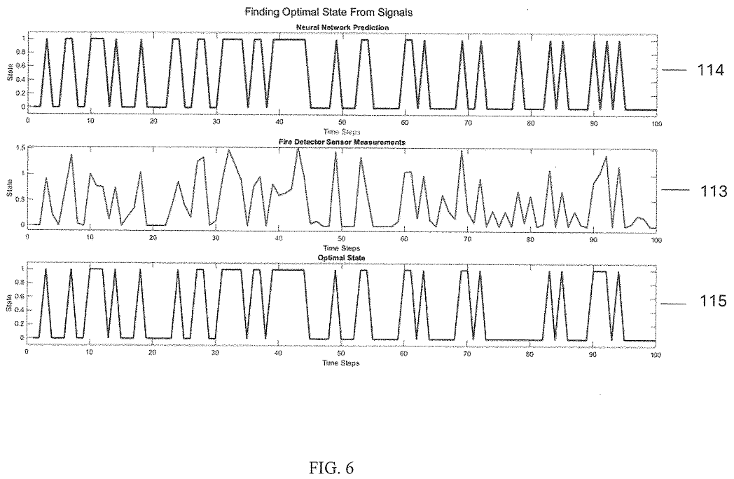

FIG. 3A is a diagram illustrating the digital logic when fire sensor 102 detects detector signal 105 and fire status report 124 is not generated. FIG. 3B is a diagram illustrating the digital logic when fire sensor 102 detects detector signal 105 and fire status report 124 is generated. FIG. 3C is a diagram illustrating the digital logic when fire sensor 102 does not detect detector signal 105 and fire status report 124 is generated. FIG. 4A is a diagram illustrating the digital logic when fire sensor 102 does not detect detector signal 105, fire status report 124 is generated, and a smoke detector detects a signal. FIG. 4B is a diagram illustrating the digital logic when fire sensor 102 does not detect detector signal 105, fire status report 124 is not generated, and a smoke detector detects a signal. FIGS. 3A, 3B, 3C, 4A, and 4B will be discussed together. In FIGS. 3A, 3B, 3C, 4A, and 4B the signals of 1s and 0s at the far left and the far right of the figures represent the state of the circuit. Thus, a state of 1 means the circuit is on, and a state of 0 the circuit is off.

Once filter module 110 has received detector signal 105 and fire status report 124, filter module 110 can input detector signal 105 and fire status report 124 into digital logic to determine if a fire is present or not (Step 140). The digital logic in filter module 110 can be a simplified digital circuit utilizing “AND” and “OR” logic gates as well as visual indicators such as LEDs. The diagrams representing the digital logic can be modified in more sophisticated ways as needed. The digital logic in filter module 110 can send either a high or low output signal to control unit 116 which can interpret the presence of a fire. The digital logic in filter module 110 can notify control unit 116 of a fire via the detector signal 105 and fire status report 124. If the detector signal 105 is sustained for a predetermined amount of time, the control unit 116 can be sent a signal notifying of a fire regardless of fire status report 124. If fire status report 124 is on, but detector signal 105 is off then a warning indicator can be sent to the control unit 166 so the flight crew and/or the pilot can still be notified of the fire situation and monitor it. Control unit 116 can be modified to also help aid in monitoring the fire situation to help with a quicker reaction time in the event a fire flares up. A person of ordinary skill would recognize that there are many potential options beyond those discussed here within the scope of the disclosure when designing the digital logic used in filter module 110. Although the digital logic is shown within the context of circuit diagrams in FIGS. 3A, 3B, 3C, 4A, and 4B, a person of ordinary skill would recognize that similar logic can be implemented using other techniques including software and other known techniques.

Filter module 110 can use other algorithms alongside digital logic or outside the digital logic as well. A Kalman filter could also be integrated into the fire detection system 100 to estimate fire detection signals. In one example, once filter module 110 has received detector signal 105 and fire status report 124, filter module 110 inputs detector signal 105 and fire status report 124 into Kalman filter 112 to calculate optimal state estimate 115 (Step 140). Kalman filter 112 combines the predicted state estimate (fire status report 124) and the measurement (detector signal 105). Kalman filter 112 can produce estimates of fire detection more accurate than can be produced individually by confirmation module 108 and/or fire sensor 102, because Kalman filter 112 can use a joint probability distribution over the inputs provided for each timeframe that Kalman filter 112 is used.

Other algorithms besides digital logic or a Kalman filter can be used to process detector signal 105 and the fire status report 124 including, but not limited to, an extended Kalman filter, an unscented Kalman filter, using other distributions within a Kalman filter besides a normal gaussian distribution, etc. By combining a predicted state estimate and a measurement in a Kalman filter, filter module 110 can increase the accuracy of fire detection and helps prevent false positives (reporting a fire when no fire is present).

### Optimal State Estimate

FIG. 5 is a diagram contrasting an optimal state estimate 115 generated by Kalman filter 112 to a predicted state estimate 114 and a measurement 113. Kalman filter 112 can take the predicted state estimate 114 (from the fire status report 124) provided confirmation module 108 and measurement 113 (from detector signal 105) provided by fire sensor 102 and generate optimate state estimate 115. As discussed above, by combining the predicted state estimate 114 and measurement 113 with the Kalman filter 112 the optimal state estimate 115 is a more accurate assessment of the presence of fire in the fire zone. After receiving optimal state estimate 115 from Kalman filter 112, filter module 110 sends optimal state estimate 115 to control unit 116 (step 142). Optimal state estimate 115 informs control unit 116 whether a fire is present or not.

FIG. 6 is a diagram contrasting multiple optimal state estimates 115 from multiple predicted state estimates 114 and multiple measurements 113. FIG. 6 shows the varying sensor measurements that are possible as fire sensor 102 receives various sensor signals 101. FIG. 6 also shows the various combinations of predicted state estimates 114, measurements 113, and optimal state estimates 115 that can be generated by fire detection system 100. In this example a neural network is used as trained DL model 120 to create the predicted state estimate 114. In another example, any trained DL model other than a neural network can be used to create the predicted state estimate 114.

### Control Unit

Control unit 116 receives a digital signal output (also referred to as an output signal) from filter module 110. Control unit 116 can be an automated system that acts based on the fire status report 124, a notification system that provide notice of responder that will act, etc. Examples of control unit 116 can be an airplane crew, an airplane fire suppression system, building security, a police department, a fire department, security systems, fire response protocol systems, etc. In an example, where control unit 116 is an airplane crew, processor 104 sends fire status report 124 to the airplane crew indicating that there is a fire. Additionally, fire status report 124 can also show the airplane crew fire image 122 of the fire, camera 106 from which fire image 122 was captured or imported, and more specific information about where fire was detected in fire image 122.

In another example, where control unit 116 is an airplane fire suppression system, when provided with fire status report 124, the airplane fire suppression system can initiate fire response protocol (which may include alarms, fire suppression systems), alert first responders (such as onboard crew, ground-based firemen, police, etc.) of the fire, and provide first responders with the information included in fire status report 124. In instances where a fire is not actually present, such as in the above example, fire detection system 100 does not communicate that there is a fire to control unit 116, thereby preventing false positives before they occur.

### Predetermined Frequency

In some examples, fire detection system 100 can also generate fire status report 124 without needing sensor signal 101. In this example, fire detection module 104 can include a timer and a predetermined frequency in which fire detection module 104 checks for a fire by turning on camera 106 at set intervals. For example, if the predetermined frequency is 60 minutes, fire detection module 104 can be programmed such that every 60 minutes, fire detection module 104 can send a signal to camera 106 to take images of the fire zone. The series of images can be passed to confirmation module 108 for analysis. Fire detection system 100 can proceed through steps 130-142 shown in FIG. 2 eventually generating fire status report 124. If fire status report 124 indicates that a fire has been detected, then fire detection module 104 could send the fire status report 124 to control unit 116. This allows fire detection system 100 to proactively search for fires.

In this example, fire detection system 100 can regularly monitor an area (or multiple areas) for fires and detect fires without needing to be alerted, by fire sensor 102 or an external source, that a fire may be present. Passively monitoring for fires allows fire detection system 100 to detect fires that could have been otherwise undetected by all other systems. Thus, fire detection system 100 can further increase its ability for fire detection. The functionality of passive fire detection described above can be present in any embodiment of fire detection system 100. The predetermined frequency (for fire detection module 104 to check for a fire) can be any length of time desired and can be changed at any time by reprogramming fire module 104.

### Aerospace Application

Fire detection system 100 can operate in any applicable environment, including without limitation aerospace (e.g., a fixed wing or rotary wing aircraft, space vehicle, etc.) applications, maritime (e.g., surface or subsurface ships) applications, and terrestrial (e.g., motor vehicle, train, building, etc.) applications.

In one example, fire detection system 100 can operate on an airplane. Fire detection system 100 can interface with an airplane fire controller unit to detect fires on an airplane. Fire sensor 102 can register any smoke on an airplane as a fire. Cameras on board the airplane can be used in conjunction with fire detection system 100 to determine if there is a fire on the airplane.

Control unit 116 in this airplane example can be an alert sent to the airplane crew (that there is a fire on the airplane), an alert that there is a fire can be sent to the airplane's fire response protocol system which can trigger fire response protocols to go into effect (such as discharging fire extinguishers, etc.), an alert that there is a fire can be sent to the pilot, flight crew, ground control, a control tower, first responders, or any other party that fire detection system 100 has been programmed to send the alert to with the use of the airplane's communication technology.

Fire detection system 100 can operate continuously, monitoring for fires while the plane is on the ground, in the air, or while the airplane is not in service if power is supplied to the fire detection system 100. Fire detection system 100 can also operate in the event the aircraft loses power. A backup battery system can be used. In one example, fire detection system 100 can look for fires on a programmed frequency, without external input.

In one example, fire detection system 100 can receive an image from a non-sensor source (such as from a crewmember on a flight or from security within a building) and can detect fire in the image. Then fire detection system 100 can send all relevant information determined about the fire from the image back to the source of the image or to the relevant authorities (such as the pilot or the police).

In one example, fire detection system 100 can operate without all of the following elements: fire sensor 102, camera 106, filter module 110, Kalman filter 112, and optimal state estimate 115. In this example, fire detection system 100 can receive a fire image 122 from an outside source. Fire detection system 100 sends the fire image 122 to fire detection module 104, which then sends the fire image 122 to confirmation module 108. Confirmation module 108 analyzes the fire image 122, uses trained DL model 120 to determine if a fire is present in the fire image 122, and then generates fire status report 124. Confirmation module 108 sends fire status report 124 to control unit 116. In this example, fire detection system 100 can be implemented in any electronic system with access to a camera. If a camera is present, fire detection system 100 can continuously monitor the environment for a fire using the camera. If a camera is not present, fire detection system 100 can import a fire image 122 from an external source.

### DL Training Module

FIG. 7 is a block diagram of deep learning training module 118. FIGS. 6 and 7 provides further explanation into the processes conducted within DL training module 118. DL training module 118 can, for example, include setup phase 146, training phase 148, testing phase 150, and post-testing phase 150. Individual subcomponents of each phase are shown in FIGS. 6 and 7. DL training module 118 can include a processor.

DL training module 118 operates in four phases: setup phase 146, training phase 148, testing phase 150, and post-testing phase 152. The phases of DL training module 118 are shown as boxes for the purpose of clarity. In one example, all the phases of DL training module 118 are not physical parts and can be arbitrary groupings of code within DL training module 118. All subparts of DL training module 118 can be accessed by DL training module 118 at any time.

The purpose of DL training module 118 is to create trained DL model 120. DL training module 118 uses deep learning training to improve the accuracy of trained DL model 120 at detecting fires. In this disclosure, the term “training” is used to refer to an artificial intelligence (AI) method that teaches a computer how to process data in a way that is inspired by the human brain. In this disclosure, the term “training” is used to refer to the same process as “deep learning training” or “artificial intelligence training.” Deep learning is also a reference to models with additional or deeper layers in the neural network.

The term deep learning training, machine learning training, or training, as referred to hereto, refers to the training processes described herein and can refer to artificial intelligence training that does not employ deep learning. Machine learning is a subset of artificial intelligence (AI) and learns patterns from data. Deep learning is a subset of machine learning and uses neural networks for complex tasks. Deep learning training is an iterative process. Multiple cycles (or epochs or rounds) of deep learning training can be conducted before training is considered completed. Cycle of training, round of training, and iteration of training are all used synonymously in this disclosure. Each cycle of training incorporates elements of setup phase 146, training phase 148, testing phase 150, and post-testing phase 152. Each cycle of training can include any number of epochs desired.

### Setup Phase

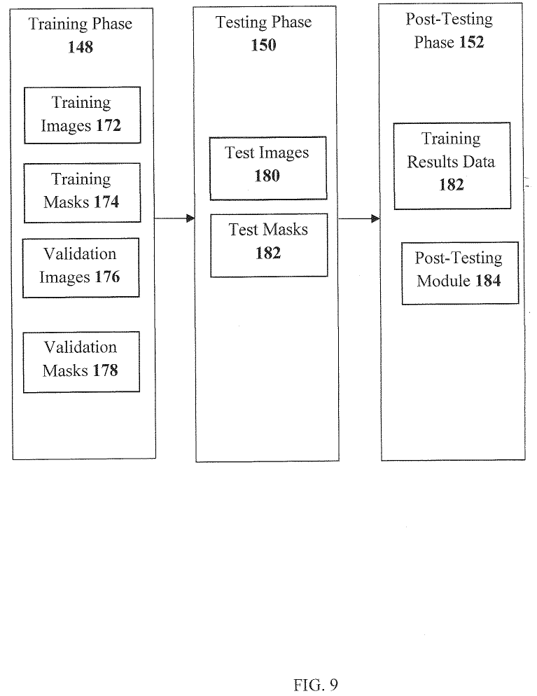

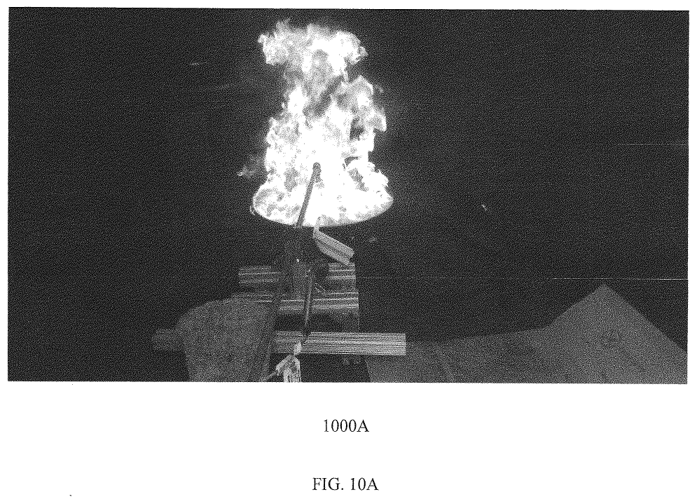

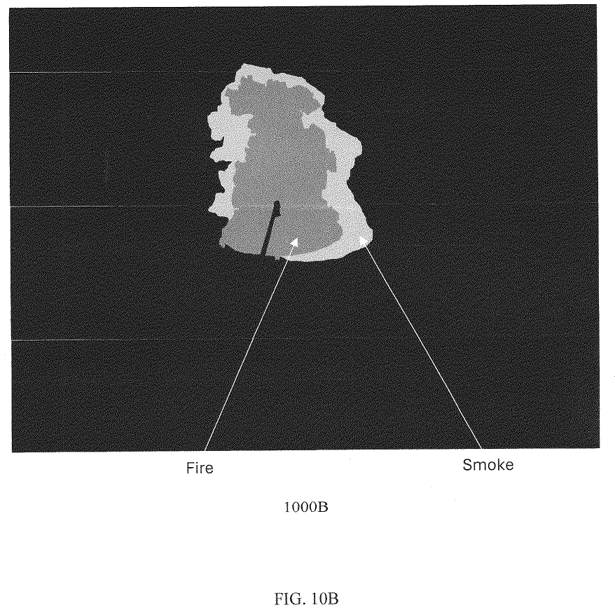

FIG. 8 is a more detailed block diagram of setup phase 146. FIG. 10A is an example of a fire image obtained by the fire detection module 104 of the fire detection system 100 of FIG. 1. FIG. 10B shows the fire image of FIG. 10A with classes outlined using an image annotation tool to indicate regions displaying fire and smoke. FIG. 10B also shows a mask of the fire image of FIG. 10A that was generated based on the classes of FIG. 10B. FIGS. 9, 10A, and 10B will be discussed together.

Setup phase 146 can, for example, include deep learning model 158, training and validation data 160, class names, class labels, pixel label datastore 162, an algorithm, deep learning semantic capable conversion 164, model weights 166, training parameters 168, and memory 170.

Setup phase 146 is the first phase in a particular cycle of deep learning training. The first cycle of training is unique, because the groundwork for training needs to be established. During setup phase 146, all new information necessary for a particular cycle of deep learning training is imported (or loaded). This new information can include training and validation data 160, training images 172, training masks 174, validation images 176, validation masks 178, test images 180, test masks 182 etc.

### Memory

DL training module 118 includes memory 170. Memory 170 is configured to store information and, in some examples, can be described as a computer-readable storage medium. Memory 170, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 170 is a temporary memory. As used herein, a temporary memory refers to a memory having a primary purpose that is not long-term storage. Memory 170, in some examples, is described as volatile memory. As used herein, a volatile memory refers to a memory that that the memory does not maintain stored contents when power to the memory 170 is turned off. Examples of volatile memories can include random access memories (RAM), dynamic random access memories (DRAM), static random access memories (SRAM), and other forms of volatile memories. In some examples, the memory is used to store program instructions for execution by the processor.

Memory 170, in some examples, also includes one or more computer-readable storage media. The storage media can be configured to store larger amounts of information than volatile memory and, further, can be configured for long-term storage of information. In some examples, memory 170 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories. Memory 170 can contain all the information stored in DL training module 118.

### DL Model

During setup phase 146, deep learning (DL) model 158 is chosen. DL model 158 can be any AI algorithm including neural networks, convolutional neural networks, dense neural networks, deep neural networks, large language models, deep learning, machine learning, deep learning, linear regression, logistic regression, naïve bayes, support vector machines, transfer learning models, RESNET, MobileNet, DenseNet, etc. Any of these algorithms is selected to form the backbone architecture of DL model 158. DL model 158 needs an algorithm to later perform a deep learning (DL) semantic capable conversion 164 on the algorithm.

DL model 158 can be chosen to meet the needs of the context in which fire detection system 100 is used. Some algorithms perform better in different contexts and with different types of training data. During training, the algorithm used for DL model 158 or the type of algorithm used for DL model 158 can be changed in order to improve the effectiveness of training and the accuracy of trained DL model 120. One version of DL model 158 is chosen to create trained DL model 120. Trained DL model 120 is created from the version of DL model 158 that is most accurate at fire detection and verification given the quantity and types of data available for training and the ultimate needs of the particular use case in which fire detection system 100 is employed.

FIG. 10A illustrates an example of an image 1000A. FIG. 10B illustrates image 1000B which outlines the classes (e.g., regions of fire and smoke) in image 1000A. FIG. 10B illustrates a mask 1000B of image 1000A. FIG. 10A and FIG. 10B will be discussed together with FIGS. 7, 8, and 9.

During setup phase 146, class names, class labels (also referred to as labels), and label ids that are desired are set. In the context of fire detection system 100, a label represents a class. A class can represent a name, symbol, or any other identifier given to a particular group to help DL model 158 classify or identify objects in an image. Labels are used to categorize sections of an image particularly in computer vision. For example, in an image, such as 1000A (1000A is the image shown in FIG. 10A), the section of the image that shows fire can be labeled as fire, the section of the images that shows smoke can be labeled as smoke, and the section of the image that does not show fire or smoke can be labeled as background. Any number of labels can be created to categorize different sections of an image.

For example, 1000A in FIG. 10A can be split into two classes (fire and background), three classes (fire, smoke, and background), or any number of classes. The label “background” is used to refer to the background of the image that does not include the fire or the smoke. The label “background” can also be used to refer to sections of an image that are unlabeled or do not have another label. The label “background” can be replaced with other labels such as “unlabeled.” In one example, the densities of smoke and fire can also be used as additional classes.

In one example, the background of an image can be isolated using Mask R-CNN which stands for Mask Region-based Convolutional Neural Network. Mask R-CNN can be used to isolate the background from the fire or other labels in an image. Each class is associated with a label id. The label id is used to reference the class by a pixel value. For example, the labels “fire”, “smoke”, and “background” can have corresponding label ids of 255, 125, and 0. Any pixel value can be used for each label. Different pixel values are used for different labels so that DL model 158 can differentiate between labels during training phase 148. The label ids are used later to aid DL model 158 in differentiating between different labels while analyzing images and masks. Labels help DL model 158 to distinguish between the various classes (fire, smoke, background, etc.). Semantic segmentation utilizes computer vision task where the goal is to classify each pixel in an image into specific categories or classes using a deep learning algorithm.

### Segmentation Feature Extraction Improvement Method

During setup phase 146, DL model 158 needs to improve the feature extraction of a model. To do this, backbone model (DL model 158) is integrated with a semantic segmentation model such as UNet, DeepLabV3, FastFCN, etc. In this disclosure, this integration is called semantic feature extraction improvement method 164. Using a backbone model converts DL model 158 to be able to perform feature extraction more effectively and therefore perform better semantic segmentation. An example of semantic feature extraction improvement method is by taking a semantic segmentation model and using a backbone model to perform more efficient feature extraction (using convolutional neural network, very deep convolutional network, RESNEt, MobileNet, etc.) for a semantic segmentation network such as FCN, Deeplab (DeepLabV3+), U-NET, etc.

In one example, the backbone architecture of DL model 158 is a neural network. The backbone neural network for a semantic segmentation network acts as the encoder part of the segmentation architecture to help extract features from input images into the model. Downsampling is used in convolutional neural networks (CNNs) for reducing memory consumption. Downsampling works by reducing the spatial dimensions of feature maps while preserving or even increasing their depth. Downsampling a CNN can help to reduce the computational complexity and memory usage by decreasing the size of the feature maps which can allow the model to process larger inputs more efficiently.

Similarly, aggregating context around a feature helps in segmenting the feature better, which can be accomplished using atrous convolutions (also known as dilated convolutions). The application of the depthwise separable convolution to both atrous spatial pyramid pooling and decoder modules results in a faster and stronger encoder-decoder network for semantic segmentation. Incorporating backbone models with these abilities can be used to allow DL model 158 to perform semantic segmentation more effectively, which ultimately increases the accuracy DL model 158 once DL model 158 has finished training.

Another example of an architecture that can accomplish semantic feature extraction improvement method 164 s is a multi-layered model that aids in the feature extraction of the model. Those layers of the model could include things like convolutional layers, pooling layers, other operations like normalization and activation functions (which help to introduce non-linearity to a network and enable more complex pattern learning), etc.

Transfer learning can also be used to improve semantic segmentation models. Transfer learning is a powerful method to use as a backbone to the segmentation model. Transfer learning is when you have a model that was developed for a particular task and then that model is reused as the starting point for a model on a second task. This method leverages an already pre-trained model which has been trained on a large dataset to solve new but related tasks (in this case classification). Transfer learning models would include the use of ResNET, DenseNET, MobileNet, etc.

### Training Parameters

During setup phase 146, the training parameters 168 for the current iteration (current round) of the deep learning training are set. Determining which training parameters 168 are necessary depends on the type of algorithm that DL model 158 is using in the current iteration. Examples of training parameters 168 are optimizers, epochs, validation frequency, patience (the number of epochs with no improvements after which training will be stopped), batch size, number of hidden layers, number of total layers, number of nodes, distributions, equations, weights, hyperparameters, etc. In one example, training parameters 168 can be set to any number of epochs. Careful monitoring of training and validation metrics is important to prevent overfitting and ensure the model generalizes well to unseen images (also known as never-before seen images).

In one example, training parameters 168 can be set at a range of 1 to 500 epochs. However, too few epochs can lead to insufficient training and too many epochs can lead to overfitting of DL model 158 on the training data. Insufficient training is when the model does not perform well because it has not had the opportunity to learn enough. Overfitting is when an algorithm spends too much time training on a particular dataset, such that the algorithm's performance is very high when evaluating the training dataset, however when the algorithm is shown unseen images, the performance of the algorithm is relatively low.

### Training Phase

FIG. 9 is a more detailed block diagram of the training phase, testing phase, and post-testing phase of FIG. 7. Training phase 148 can, for example, include training images 172, training masks 174, validation images 176, and validation masks 178. During training phase 148, all the preparations for the current iteration of training have been set, and the current iteration of deep learning training begins. During training phase 148, DL training module 118 uses training images 172, training masks 174, validation images 176, and validation masks 178. Training and validation data 160 includes a training dataset and a validation dataset. A training dataset can include training images 172 and training masks 174. A validation dataset can include validation images 176 and validation masks 178.

### Training Images

Training images 172, training masks 174, and validation masks 178 are all directories which hold all of the training images, mask images, and validation images, respectively. Each image in training images 172 has a corresponding mask in training masks 174. Each image in validation images 176 can have a corresponding mask in validation masks 178. Each mask in training masks 174 is created using an image in training images 172. To create a mask, an image is selected and regions of interest within that image can be determined using an image annotation tool primarily for creating labeled datasets for computer vision applications. Some examples of regions of interest are pixels of an image associated with fire, smoke, background, etc. Once an image is selected, regions of interest are then outlined (also referred to as annotated) within that image using the image annotation tool. For example, the regions of interest in FIG. 10A are outlined in FIG. 10B. FIG. 10B outlines the pixels associated with the fire in one color and the smoke in another color. In another example, the classes in the image were outlined using a different image annotation tool. For training images 172 and validation images 176, the regions of interest can be outlined (to create a mask) by a human or a computer program.

For example, in FIG. 10A and FIG. 10B there is an image 1000A, image 1000B (also referred to as mask 1000B) where the regions of image 1000A have been outlined, and mask 1000B where a mask has been created from image 1000A. Mask 1000B corresponds to image 1000A. To create mask 1000B, image 1000A was selected, the fire, the smoke, and the background, in image 1000A were outlined. Once the outlining within image 1000A was completed, the outlined sections of the image were each given one label (an example label is visible spectrum fire, ultraviolet fire, infrared fire, etc.) and the non-outlined sections of the image are given another label (an example label is background). For every image such as image 1000A there can be an associated mask such as image 1000B.

Now the mask 1000B has been completed, once the entire image 1000A has been split into the regions of interest, and the regions of interest have been labeled. The outline of fire in mask 1000B is a single channel ranging from white to black. The outline of the background in mask 1000B is shown in black. The range for each class can be identified in any way if it falls within the single channel range. Each image in training images 172 and validation images 174 has a mask that was created using the above technique of coloring or outlining and labeling. In one example, only portions of a mask, but not the entire mask are labeled. However, labeling an entire mask can increase the efficiency of training and the accuracy of confirmation module 108 at the end of training.

Data augmentation can be used to increase the number of training images by modifying training images 172, training masks 174, validation images 176, and validation masks 178 to form new images that can be used for training. Rotating an image, blurring an image, cropping an image, distorting an image, etc., are all data augmentation techniques that can be used to form new images that can be used for training. Every image that DL model 158 uses in training (ex: training images 172, validation images 176, and test images 180) can be 3 channel (24 bit) RGB (red, green, blue) images. Every mask that DL model 158 uses in training (training masks 174 and validation masks 178) can be one channel (8 bit) images. A one channel image is a grayscale image composed of colors in between (and including) black and white. Mask 400C is a grayscale image. A three-channel image is an image in color (RGB image). In one example, training masks 174 and validation masks 178 in DL model 158 can be any combination of one channel and three channels images including, all one channel images or all three-channel images. Each label can be distinguished by its color in a mask.

Any drawing annotation tool such as labelME, labelbox, superAnnotate, ImageTagger, Computer Vision Annotation Tool, COCO Annotator, etc. can be used to create any mask used during training (such as training masks 174 and validation masks 178). Masks can be used to categorize image pixels into any number of labels. For example, masks can show fire and background within an image or masks can show fire, smoke, and background in an image. Each label in a mask is assigned a label pixel value between 0 and 255 or another specific value within the single channel range. The label pixel values allow DL model 158 to distinguish between labels. The pixel label values for each image and mask in DL training module 118 can be stored in pixel label datastore 162. Pixel label datastore 162 is used so the model can associate pixels to the corresponding labels. This association helps the models to learn.

Every pixel in an image can be labeled. Thus, masks accurate at a pixel level (accuracy for a single pixel) are created. During training phase 148, DL model 158 is given training images 172 and training masks 174 and can be instructed to analyze each training image 172 and its corresponding training mask 174 and learn how to generalize features from each image. Each corresponding training mask 174 can be referred to by DL model 158 (similar to a “cheat sheet”) in order to help DL model 158 learn how to categorize pixels. Each corresponding training mask 174 can have correct labels of each pixel in training image 172 and can be used as a reference for DL model 158 to use during training.

DL model 158 can learn to map each pixel in training image 172 to the correct label in the corresponding training mask 174 by pixel-level association. In one example, each training image 172 and its corresponding training mask 174 are dimensionally the same size. Having each training image 172 and its corresponding training mask 174 be the same size allows DL model 158 to correctly align the extracted features from each training image 172 to the labels in the corresponding training mask 174.

Semantic segmentation is an algorithm that associates a label or category with every pixel in an image. Semantic segmentation is used to recognize a collection of pixels that form distinct categories. By using semantic segmentation during training, DL model 158 learns what the value of what a pixel class (e.g. a class pixel could include fire, smoke, background, etc.) is. Through repeatedly analyzing images, DL model 158 learns how to classify each pixel into meaningful categories based on the attributes or features extracted from the image eventually becoming proficient at identifying the pixels associated to each class in an image. Thus, when DL model 158 is later shown an unseen image outside the training and validation datasets in testing phase 150, DL model 158 can analyze the image pixel by pixel and categorize which pixels are fire pixels, or smoke pixels, or background pixels. This allows DL model 158 to identify fire events present in an image.

Features are the attributes or properties extracted from input data that is used to make pixel-level predictions about what class each pixel belongs to. DL model 158 can analyze each pixel in an image to determine attributes or features within that image. Attributes can include color of the pixel, temperature of the pixel (such as when the image was taken with a thermal imaging camera), location of the pixel (how close is the pixel to other fire and/or smoke pixels), etc. Fire attributes are attributes that indicate that a pixel contains fire. Smoke attributes are attributes that indicate that a pixel contains smoke. Attribute data is data about an attribute. DL model 158 can analyze each pixel in an image and extract fire attribute data, smoke attribute data, and other types of attribute data from the pixel. DL model 158 can then review all of the attribute data from a single pixel and determine whether fire and/or smoke is present in the pixel based on previous training. DL model 158 can use the classes and labels within training masks 174 to know exactly which pixels are associated with fire pixels and smoke pixels. DL model 158 can analyze the labeled fire pixels in training masks 174 to determine what are the attributes of each fire pixel and which attributes indicate that this specific pixel is a fire pixel. DL model 158 can use information it learned from the fire pixel attribute data during training when analyzing the attribute data of an unknown pixel later. This process of extracting and analyzing attribute data can be repeated for any class that is labeled within training masks 174. Thus, DL model 158 can be capable of analyzing various types of attribute data and using the analysis of the attribute data to determine the presence of a class in an image.

In one example, attribute data extracted from each pixel in an image can be used to create a segmentation map. The segmentation map can be used to interpret which class each pixel should be categorized within (fire pixel, smoke pixel, or whatever other class that the model is detecting and being trained on.

DL model 158 can become very accurate at detecting fire, smoke, background, or whatever else is labeled during training. Once training has completed, the most accurate version of DL model 158 will be used as trained DL model 120. Some machine learning or deep learning algorithms can be more accurate in some use cases than other algorithms. The types of training parameters 168 and DL model 158 that are most accurate for a specific use case depends on what the use case is. Additionally, the types of labels necessary for masks used during training also depend on the end use case. Additional AI models and algorithms can be used in parallel or series with DL model 158 for further improvement to the performance of trained deep learning model 120.

### Validation Images

All of the available images used in training phase 148 are separated into training images 172 and validation images 176. In one example, 80% of the images that are used during training phase 148 are used as training images 172 and 20% of the images are used as validation images 176. In another example, any distribution of available images between training images 172 and validation images 176 is possible. DL model 158 is trained using training images 172, training masks 174, validation images 176 and validation masks 178.

After a certain frequency (the validation frequency), DL training module 118 checks the accuracy of DL model 158, by testing the accuracy of DL model 158 using validation images 176 and validation masks 178. The accuracy is tested by presenting DL model 158 with several images from validation images 176 and analyzing the accuracy of DL model 158 at detecting the presence of a class (ex: fire) in the images that are presented. Validation images 176 are used to help DL model 158 generalize well to data outside of the training dataset. During training phase 148, validation data is used to help guide DL model 158 and ensure DL model 158 is learning correctly. The validation frequency determines how frequently validation images 176 and validation masks 178 are used to evaluate the model's performance. The validation frequency can be any frequency or time period desired.

Validation masks 178 are used to compare the accuracy of DL model 158 by comparing the presence (or lack of presence) of a class (ex: fire) in each pixel of validation masks 178 to the results (fire prediction) generated by DL model 158. This accuracy test using validation images 176 and masks 178 is intended to use a smaller sample size to verify that DL model 158 is training properly. If the accuracy of DL model 158 is worse than in previous training iterations, then the model's training parameters 168, hyperparameters, training images 172 and validation images 176 may need to be adjusted to improve the model's accuracy. Adding more training and validation images as well as ensuring the images are diverse and/or augmented can help the model learn features better.

These adjustments could be adjusting training parameters 168 and running a new training iteration, changing DL model 158 to a different algorithm, or any other change to improve the performance of DL model 158 during training. In one example, no validation images 176 or validation masks 178 are used during training phase 148, and testing phase 150 is solely used to check the accuracy of DL model 158.

During training phase 148, training images 172, training masks 174, validation images 176, and validation masks 178 are used to increase the accuracy of DL model 158. In one example, training phase 148 teaches DL model 158 how to detect the presence of a class (ex: fire), and once the class (ex: smoke and/or fire) is detected, using semantic segmentation, DL model 158 segments the image into regions corresponding to different classes providing a representation of the image in a way that the computer can understand. Semantic segmentation allows DL model 158 to assign a class to each pixel in an image.

During training phase 148, DL model 158 can be taught to perceive ultraviolet light by training DL model 158 using images from an ultraviolet camera or other device that can capture images in the ultraviolet light spectrum. DL model 158 can also be taught to perceive infrared light by training DL model 158 using images from an infrared camera or other device that can capture images in the infrared light spectrum. Thus, any embodiment of fire detection system 100 can detect a fire based on images taken in visible light, ultraviolet light, or infrared light when the proper camera is used to capture images. This enables fire detection system 100 to detect fires in situations where there is no visible light, but there is infrared light or ultraviolet light. Flames emit electromagnetic radiation in the infrared (IR), visible light, and ultraviolet (UV) wavelengths depending on the fuel source. Using multiple cameras internally or externally in fire detection system 100 can allow for multiple wavelengths of fires to be detected.

During training phase 148, DL model 158 can be taught that more than one scenario should be considered a fire. For example, to determine if there is a fire, DL model 158 can consider only smoke, only fire, smoke or fire, smoke and fire, smoldering fire, embers, etc. In one example, DL model 158 can be trained to determine any amount of smoke in an image is as important as a fire. DL model 158 can signal that a fire is present in instances where only smoke is present (ex: smoldering fire). For example, if there is smoke in an image, but no fire is present, the model can still predict a fire (i.e., mark the image as containing a fire). Characterizing smoke as fire can accommodate the desired needs of control unit 116. Characterizing smoke as fire can be useful instances where smoke can indicate a smoldering fire or the start of a fire.

### Testing Phase

Testing phase 150 can, for example, include test images 180 and test masks 182. During testing phase 150, test images 180 and test masks 182 are used. Testing phase 150 is designed to test how accurate DL model 158 has become from the training process. Once DL model 158 has entered testing phase 150, training for the current training iteration has been completed. Test images 180 are a separate set of images that DL model 158 has never seen and are images outside the training and validation datasets. DL model 158 is given test images 180 and asked to detect whether a fire (also referred to as a fire event) is present in the images. In an example, DL model 158 can also be asked to detect the location of fire that are present in the images. Test masks 182 can be used to help with confirming you are testing correctly, and your model is making good predictions and/or inferencing correctly. Test masks 182 can be used to generate accuracy measurements and other assessment metrics in training results data 182.

In one example, during testing phase 150 only a portion of test images 180 are used during a single iteration of training. The purpose of test images 180 is to provide unseen images to DL model 158 to see if the trained model generalizes well outside the training and validation datasets. If all test images 180 are presented to DL model 158 during one iteration of training, then there are no unseen images remaining in test images 180 and the testing may not be as effective. So, in subsequent iterations, test images 180 have already been seen at least once when DL model 158 enters testing phase 150. Training too many iterations on the same images can lead to overfitting DL model 158. Using different subsets of testing images 172 in each iteration of training can help to determine what classes the model 158 has difficulty generalizing, can increase the overall performance of DL model 158 when shown new data, and avoid overfitting DL model 158. Test images 180 are not presented to DL model 158 during training phase 148 to ensure DL model 158 has learned from training and validation data 160 and can generalize unseen images outside of the training and validation datasets. During the testing phase, testing metrics can be created to analyze the overall performance of the model. The purpose of test images 180 are to simulate how DL model 158 will perform in the real-world where DL model 158 will need to be able to detect new fires and/or smoke events.

Once DL model 158 has finished testing during testing phase 150 of a particular iteration, then post-testing phase 152 begins. In post-testing phase 152, the results of testing phase 150 are analyzed and next steps for training are determined. Training results data 182 is all the results data received during testing phase 150. Post-testing phase 152 determines how accurate DL model 158 was considering all the data that DL model 158 output during testing phase 150. The person or program in charge of the initial training of DL model 120 is also referred to as the training operator in this disclosure. In post-testing phase 152, the training operator can determine how accurate the model's predictions (the analysis of where each class is present in the image) are based off of generated masks by DL model 158, statistical tools, and analysis.

There are several different ways that the accuracy of DL model 158 can be evaluated including using confusion matrices, Jacobian matrices, t-test formula, other statistical tools, statistical analysis, etc. Confusion matrices can be split into four categories: false positives, true positives, false negatives, and true negatives. Accuracy can be calculated on a confusion matrix using the formula: accuracy=(true positives+true negatives)/(true positives+true negatives+false positives+false negatives). Also, using statistical tools can aid in evaluating the performance of a model.

A confusion matrix can provide accuracy results for each class that the model was trained on. Thus, when analyzing the accuracy of DL model 158, you can measure different accuracies for each class and label. For example, analyzing training results data 182 after a round of deep learning training can reveal a 70% accuracy in background (meaning that pixels were correctly identified as background pixels with a 70% accuracy), 85% accuracy of fire (meaning that pixels were correctly identified as fire with a 85% accuracy), and a 91% accuracy of smoke (meaning that pixels were correctly identified as smoke with a 91% accuracy. Metrics can also show what classes the model predicted versus what classes the actual prediction should have been. This example represents the varying accuracies that can occur between each class. The representation of each class in training and validation data 160 can affect how well DL model 158 generalizes and predicts a particular class correctly. If images have a high degree of class imbalance (a higher proportion of the images include one class and do not include another class), DL model 158 may tend to predict higher accuracies for the higher represented classes. Using weights can also help to ensure DL model 158 is learning meaningful patterns from the data and can prevent models from converging to trivial solutions in instances where one class is more represented than another class.

### Post-Testing Phase

Post-testing phase 152 can, for example, include training results data 182 and post-testing module 184. Post-testing module 184 utilizes the training operator to analyze training results data 182 during post-testing phase 152 to determine the accuracy of DL model 158. Then post-testing module 184 decides based on training results data 182 whether DL model 158 is finished training or if DL model 158 needs to continue another iteration of training.

If DL model 158 needs to continue training, then post-testing module 184 returns DL training module 118 to setup phase 146. This transition from post-testing phase 152 back to setup phase 146 is illustrated by arrow 154. Once DL training module 118 has returned to setup phase 146 after completing an iteration of training, some changes are made in the next iteration of deep learning training. Changes in the next iteration of training can include changing DL model 158 to a different algorithm, changing training parameters 168, revising training images 172 and validation images 176, etc. Revising training images 172 and validation images 176 can include more precise labeling of images, better quality images, different types of data augmentation, etc.

Multiple iterations of deep learning training can be conducted in DL training module 118 until the accuracy of DL model 158 reaches a predetermined or acceptable level (such as 90% accuracy or 95% accuracy). The predetermined level of accuracy can be indicated by the client who wants to use the fire detection system or can be determined by the person that is overseeing the training of DL training module 118. Training results data 182 retrieved from testing phase 150 is used to determine if the accuracy of DL model 158 is sufficient in each iteration of deep learning training.

Once DL model 158 satisfies the predetermined accuracy level during testing phase 150, then post-testing module 184 determines that DL model 158 is ready to deploy onto a fire detector unit (to be used commercially). Then post-testing module 184 stores the approved version of DL model 158 in confirmation module 108 as deep learning (DL) model 120. The storing of trained DL model 120 to memory from post-testing module 184 is shown by arrow 156.

Confirmation module 108 is a specific version of DL model 158 with specific training parameters 168 that has achieved a predetermined level of accuracy when tested for fire detection on test images 180. Confirmation module 108 is a fully trained model that does not need to undergo further training (to achieve a predetermined accuracy) once it has been created. Once the confirmation module 108 is ready, it can be uploaded into the memory of fire detection system 100. Chips for storing in memory and deploying configuration module 108 can range from high performance GPUs and system on chips (SoCs) to specialized neural network accelerators and microcontroller units (MCU) for low-power embedded devices, FPGAs, etc. Memory in fire detection system 100 can have all the characteristics of memory 170 or can be completely different than memory 170.

DL training module 118 can be included in fire detection system 100. In some examples, DL training module 118 can be completely separate from fire detection system 100, and a confirmation module 108 can be imported to fire detection 100 before fire detection 100's initial operation. Fire detection system 100 operates most effectively once initial training has been completed. In fire detection system 100, once initial training has been completed, DL training module 118 is not used again (unless the model needs to be reworked for any reason), and trained DL model 120 is not changed once it has been created.

### Additional Training

If additional training data is needed, then additional training and validation images can be collected and the training operator in charge can create masks for the additional images. Tuning of the hyperparameters and parameters of DL model 120 can be evaluated to determine if any further adjustments need to be made. Data augmentation techniques can be explored to create more diverse training and validation datasets that can enable the model to better learn. Any previously uploaded revision of the model to the firmware of fire detection system 100 can be removed and replaced with a newer trained revision of the model after the model receives additional training. In one example, fire detection system 100 can use information obtained while in operation for further training of trained DL model 120. Any combination of information from fire sensor 102, sensor signal 101, fire image 122, information about fire image 122, fire status report 124, optimal state estimate 115, and any other information generated or received by fire detection system 100 can be sent by filter module 110 to post-testing module 184 in DL training module 118. The person or program in charge of the initial training of DL model 204 is also referred to as the training operator in this disclosure. The training operator in charge of initial training of DL model 120 can analyze the information sent to post-testing module 184 by filter module 110 and determine the accuracy of trained DL model 120. If trained DL model 120 is even slightly incorrect in detecting fire in fire image 122 or in detecting the location of fire in fire image 122, then the training operator can create a mask using image 122 that correctly indicates the location of fire (or lack of fire) in fire image 122.

Fire images 122 can be added to training images 172 for additional training of trained DL model 120. Another cycle of deep learning training (or multiple cycles of deep learning training) can be run to further improve the accuracy of trained DL model 120. Once trained DL model 120 has been improved to the satisfaction of the training operator, then trained DL model 120 can be updated (to be the new and improved trained DL model 120 created after additional training) and stored in the memory of fire detection system 100. By increasing the amount of training data available during training and providing additional training of trained DL model 120, fire detection system 100 can continuously improve each time the system receives an image.

Fire detection system 100 can improve the fire detection capabilities of any existing fire detection system (such as on an aircraft or building) by adding the analysis of a deep learning model using semantic segmentation. Fire detection system 100 can also operate as a stand-alone system that does not need to be integrated with a pre-existing fire detection system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention.

A fire detection system that includes a fire detection module and a confirmation module. The fire detection module receives a sensor signal from a fire sensor, causes a fire zone image of the fire zone to be captured, and transmits the fire zone image to the confirmation module for confirmation of the presence of a fire and/or smoke in the fire zone image. The sensor signal is indicative of a potential fire in a fire zone. The confirmation module receives the fire zone image from the fire detection module, analyzes each pixel in the fire zone image for fire and/or smoke attributes, extracts attribute data from each pixel in the fire zone image, determines the presence of fire and/or smoke in the fire zone image based on the analysis of the attribute data from each pixel in the fire zone image, creates a fire status report based on the presence of fire and/or smoke in the fire zone image, and transmit the fire status report to a control unit for follow up action.

The fire detection system of the preceding paragraph can optionally include, additionally and/or alternatively, any one or more of the following features, configurations and/or additional components:

A further embodiment of the foregoing fire detection system, wherein the fire sensor is a smoke and/or heat sensor.

A further embodiment of the foregoing fire detection system, wherein the confirmation module comprises a model that is configured to process the digital fire image to recognize fire and/or smoke in the digital fire image. The confirmation module model has been trained to determine fire and/or smoke attributes using semantic segmentation techniques, on both a plurality of training fire and/or smoke images and a plurality of masks derived from the plurality of training fire and/or smoke images. Each mask in the plurality of masks includes at least one class that categorizes a portion of the mask and a label that designates the class as being fire, smoke, or neither fire nor smoke. A combination of the class and the label is used to create attribute data about each pixel in the digital fire image. The fire status report indicates whether the confirmation module determined that fire and/or smoke is present in the fire image based on the attribute data.

A further embodiment of the foregoing fire detection system, further comprising a filter module that receives the sensor signal from the fire detection module, receives the fire status report from the confirmation module, generates an output digital signal based on the detector signal and the fire status report, and sends the digital signal to the control unit. The fire detection module sends the sensor signal to the filter module after receiving the sensor signal.

A further embodiment of the foregoing fire detection system, wherein the filter module includes digital logic.

A further embodiment of the foregoing fire detection system, wherein the filter module includes a Kalman filter.

A further embodiment of the foregoing fire detection system, wherein the fire detection module causes a plurality of fire zone images of a plurality of potential fire zones to be captured repeatedly at a predetermined frequency. The fire detection module sends the plurality of fire zone images to the confirmation module. The confirmation module receives the plurality of fire zone images from the fire detection module, determines the presence of fire and/or smoke in the plurality of fire zone images, creates a fire status report based on the presence of fire and/or smoke in the plurality of fire zone images, and transmits the fire status report to a control unit for follow up action.

A further embodiment of the foregoing fire detection system, wherein the fire detection system sends data to a deep learning training module to further train the confirmation module after the confirmation module has completed initial training.

A further embodiment of the foregoing fire detection system, wherein the fire detection module includes a camera that captures the fire zone image.

A further embodiment of the foregoing fire detection system, wherein the trained deep learning model includes a neural network.

A further embodiment of the foregoing fire detection system, wherein the fire status report includes each label and each characterizing portion corresponding to an identified fire and/or smoke condition.

A method of operating a fire detection system that includes detecting, with a fire sensor, a sensor signal indicative of a potential fire in a fire zone, transmitting the sensor signal from the fire sensor to a fire detection module, receiving, by the fire detection module, a fire zone image of the fire zone, wherein the fire zone image is captured using a camera associated with the fire detection module or imported by the fire detection module from an external source, transmitting, by the fire detection module, the fire zone image to a confirmation module, determining, by the confirmation module, the presence of fire and/or smoke in the fire zone, creating, by the confirmation module, a fire status report based on the presence of fire and/or smoke in the plurality of fire zone images, and transmitting the fire status report to a control unit for follow up action(s).

The method of the preceding paragraph can optionally include, additionally and/or alternatively, any one or more of the following features, configurations and/or additional components:

A further embodiment of the foregoing method, wherein the fire sensor is a smoke and/or heat sensor.

A further embodiment of the foregoing method, wherein the confirmation module comprises a trained deep learning model that is trained, using semantic segmentation techniques, on a plurality of fire and/or smoke images and a plurality of masks derived from the plurality of fire and/or smoke images. Each mask in the plurality of masks includes at least one label that categorizes a characterizing portion of the mask. The characterizing portion of a mask is a subsection of the mask or is the entire mask. The fire status report indicates whether the trained deep learning model determined that fire and/or smoke is present in the image.

A further embodiment of the foregoing method, further comprises receiving, by a filter module, the sensor signal from the fire detection module and the fire status report from the confirmation module, generating, via a processor in the filter module using digital electronics, and transmitting, by the filter module, the outputted state to the control unit. The fire detection module sends the sensor signal to the filter module after receiving the sensor signal.

A further embodiment of the foregoing method, wherein the fire detection module is further configured to cause a plurality of fire zone images of a plurality of potential fire zones to captured repeatedly at a predetermined frequency and to send the plurality of fire zone to the confirmation module. The confirmation module is further configured to receive the plurality of fire zone images from the fire detection module, determine the presence of fire and/or smoke in the plurality of fire zone images, create a fire status report based on the presence of fire and/or smoke in the plurality of fire zone images, and transmit the fire status report to a control unit for follow up action.

A further embodiment of the foregoing method, further comprising sending the fire status report to a deep learning training module for further training of the confirmation module.

A further embodiment of the foregoing method, wherein the fire status report includes the image.

A further embodiment of the foregoing method, further comprising sending relevant data about the fire status report or the image to a deep learning training module for further training of the trained deep learning model.

A further embodiment of the foregoing method, further comprising sending a signal that indicates the fire sensor detected a fire from the processor to a filter module, receiving the signal from the processor and the fire status report from the trained deep learning model in the filter module, sending the signal from the processor and the fire status report from the trained deep learning model to digital logic for further processing of the signal, and sending the output state to the control unit.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A fire detection system comprising:
a fire detection module configured to:
receive a sensor signal from a fire sensor, wherein the sensor signal is indicative of a potential fire in a fire zone;
cause a fire zone image of the fire zone to be received or captured; and
transmit the fire zone image to a confirmation module for confirmation of the presence of a fire and/or smoke in the fire zone image;
wherein the confirmation module is configured to:
receive the fire zone image from the fire detection module;
analyze each pixel in the fire zone image for fire and/or smoke attributes;
extract attribute data from each pixel in the fire zone image;
determine the presence of fire and/or smoke in the fire zone image based on analysis of the attribute data from each pixel in the fire zone image;
create a fire status report based on the presence of fire and/or smoke in the fire zone image; and
transmit the fire status report to a control unit for follow up action.

2. The fire detection system of claim 1, wherein the fire sensor is a smoke and/or heat sensor.

3. The fire detection system of claim 1, wherein the confirmation module comprises a model that is configured to process the fire zone image to recognize fire and/or smoke in the fire zone image, wherein the confirmation module model has been trained to determine fire and/or smoke attributes using semantic segmentation techniques, on both a plurality of training fire and/or smoke images and a plurality of masks derived from the plurality of training fire and/or smoke images;
wherein each mask in the plurality of masks includes at least one class that categorizes a portion of the mask and a label that designates the class as being fire, smoke, or neither fire nor smoke;
wherein a combination of the class and the label is used to create attribute data about each pixel in the fire zone image;
and
wherein the fire status report indicates whether the confirmation module determined that fire and/or smoke is present in the fire zone image based on the attribute data.

4. The fire detection system of claim 1 further comprising:
a filter module configured to:
receive the sensor signal from the fire detection module;
receive the fire status report from the confirmation module;
generate an output digital signal based on the sensor signal and the fire status report;
send the output digital signal to the control unit; and
wherein the fire detection module sends the sensor signal to the filter module after receiving the sensor signal.

5. The fire detection system of claim 4, wherein the filter module includes digital logic.

6. The fire detection system of claim 4, wherein the filter module includes a Kalman filter.

7. The fire detection system of claim 1,
wherein the fire detection module is further configured to cause a plurality of fire zone images of a plurality of potential fire zones to be captured repeatedly at a predetermined frequency and to send the plurality of fire zone images to the confirmation module; and
the confirmation module is further configured to:
receive the plurality of fire zone images from the fire detection module;
determine the presence of fire and/or smoke in the plurality of fire zone images;
create a fire status report based on the presence of fire and/or smoke in the plurality of fire zone images; and
transmit the fire status report to a control unit for follow up action.

8. The fire detection system of claim 3, wherein the fire detection system is configured to send data to a deep learning training module to further train the confirmation module after the confirmation module has completed initial training.

9. The fire detection system of claim 1, wherein the fire detection module includes a camera configured to capture the fire zone image.

10. The fire detection system of claim 3, wherein the trained deep learning model includes a neural network.

11. The fire detection system of claim 3, wherein the fire status report includes each label and each characterizing portion corresponding to an identified fire and/or smoke condition.

12. A method of operating a fire detection system comprising:
detecting, with a fire sensor, a sensor signal indicative of a potential fire in a fire zone;
transmitting the sensor signal from the fire sensor to a fire detection module;
receiving, by the fire detection module, a fire zone image of the fire zone, wherein the fire zone image is captured using a camera associated with the fire detection module or imported by the fire detection module from an external source;
transmitting, by the fire detection module, the fire zone image to a confirmation module;
determining, by the confirmation module, the presence of fire and/or smoke in the fire zone;
creating, by the confirmation module, a fire status report based on the presence of fire and/or smoke in the fire zone image; and
transmitting the fire status report to a control unit for follow up action.

13. The method of operating the fire detection system of claim 12, wherein the fire sensor is a smoke and/or heat sensor.

14. The method of operating the fire detection system of claim 12, wherein the confirmation module comprises a trained deep learning model that is trained, using semantic segmentation techniques, on a plurality of fire and/or smoke images and a plurality of masks derived from the plurality of fire and/or smoke images;
wherein each mask in the plurality of masks includes at least one label that categorizes a characterizing portion of the mask;
wherein the characterizing portion of a mask is a subsection of the mask or is the entire mask; and
wherein the fire status report indicates whether the trained deep learning model determined that fire and/or smoke is present in the fire zone image.

15. The method of operating the fire detection system of claim 12, further comprising:
receiving, by a filter module, the sensor signal from the fire detection module and the fire status report from the confirmation module;
generating, via a processor in the filter module using digital electronics, an outputted state; and
transmitting, by the filter module, the outputted state to the control unit;
wherein the fire detection module sends the sensor signal to the filter module after receiving the sensor signal.

16. The method of operating the fire detection system of claim 12,
wherein the fire detection module is further configured to cause a plurality of fire zone images of a plurality of potential fire zones to be captured repeatedly at a predetermined frequency and to send the plurality of fire zone images to the confirmation module; and
the confirmation module is further configured to:
receive the plurality of fire zone images from the fire detection module;
determine the presence of fire and/or smoke in the plurality of fire zone images;
create a fire status report based on the presence of fire and/or smoke in the plurality of fire zone images; and
transmit the fire status report to a control unit for follow up action.

17. The method of operating the fire detection system of claim 12 further comprising:
sending the fire status report to a deep learning training module for training of the confirmation module.

18. The method of operating the fire detection system of claim 12, wherein the fire status report includes the fire zone image.

19. The method of operating the fire detection system of claim 14 further comprising:
sending relevant data about the fire status report or the fire zone image to a deep learning training module for further training of the trained deep learning model.

20. The method of operating the fire detection system of claim 14 further comprising:
sending a signal that indicates the fire sensor detected a fire from the fire detection module to a filter module;
receiving the signal from the fire detection module and the fire status report from the trained deep learning model in the filter module;
sending the signal from the processor and the fire status report from the trained deep learning model to digital logic for further processing of the signal; and
generating, using that digital logic, a digital signal output using and sending the digital signal output to the control unit.
